(19) United States
(12) Patent Application Publication
(10) Pub. No.: US 2010/0193119 A1
(43) Pub. Date: Aug. 5, 2010

(54) HANDLE APPLICATION APPARATUS AND METHOD

(75) Inventor: Duane Kenneth Lach, Livonia, MI (US)

Correspondence Address: DYKEMA GOSSETT PLLC, 39577 WOODWARD AVENUE, SUITE 300, BLOOMFIELD HILLS, MI, 48304-5086, US

(73) Assignee: Plastipak Packaging, Inc., Plymouth, MI (US)

(21) Appl. No.: 12/363,332

(22) Filed: Jan. 30, 2009

(51) Int. Cl. B32B 37/06

(52) U.S. Cl. 156/272.2; 156/379.6; 156/366

(57) ABSTRACT

An apparatus for attaching a handle to a container includes a handle supply mechanism configured to supply one or more handles in an open configuration; a container conveyance mechanism configured to provide a container to a handle application location; and a handle applicator configured to attach or connect a handle that supplied initially in an open configuration to a portion of a container. In an embodiment, a heater is included that is configured to provide energy/heat to at least a portion of the one or more handles prior to application. In other embodiments, handles are supplied for application at an elevated temperature. Methods for attaching a handle to containers are also disclosed.

### TECHNICAL FIELD

The present invention relates to a handle application system and apparatus. The invention also includes methods for applying handles to a container.

### BACKGROUND

Plastic containers are widely used commercially in connection with a variety of products. Many containers include handles to improve the manipulation of the container and/or the dispensing of container contents. It is known to provide integrally molded handles, for example, handles that are integrally formed with the container—including handles that are formed in connection with blow molding procedures. However, for some applications, an integral handle may add additional complexity or many be less desirable for other reasons.

For certain applications it may be desirable to connect or attach a separately formed handle to a container. Without limitation, some examples of plastic containers and separately formed handles are disclosed in Applicant's co-pending U.S. patent application Ser. No. 11,841,312, which is incorporated herein in its entirety by reference.

Consequently, it is desirable to provide additional improvements and/or options associated with handle application.

### SUMMARY

The present invention discloses, among other things, an apparatus for attaching a handle to a container includes a handle supply mechanism configured to supply one or more handles in an open configuration; a container conveyance mechanism configured to provide a container to a handle application location; and a handle applicator configured to attach or connect a handle that supplied initially in an open configuration to a portion of a container. In an embodiment, a heater is included that is configured to provide energy/heat to at least a portion of the one or more handles prior to application. In other embodiments, handles may be supplied for application at an elevated temperature. Methods for attaching a handle to containers are also disclosed.

### BRIEF DESCRIPTION OF THE DRAWINGS

Embodiments of the invention will now be described, by way of example, with reference to the accompanying drawings, wherein:

FIG. 1 is a side view representation of an apparatus and system for applying handles to containers;

FIG. 2 is a front view representation of a plurality of handles and a handle supply mechanism;

FIG. 3 is perspective representation of a handle being applied to a container;

FIG. 4 is a perspective view of an embodiment of an apparatus for applying a handle to a container;

FIG. 5 is a flowchart of a method for applying a handle to a container; and

FIG. 6 is a side elevation view of a container that may be used in connection with embodiments of the present invention.

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

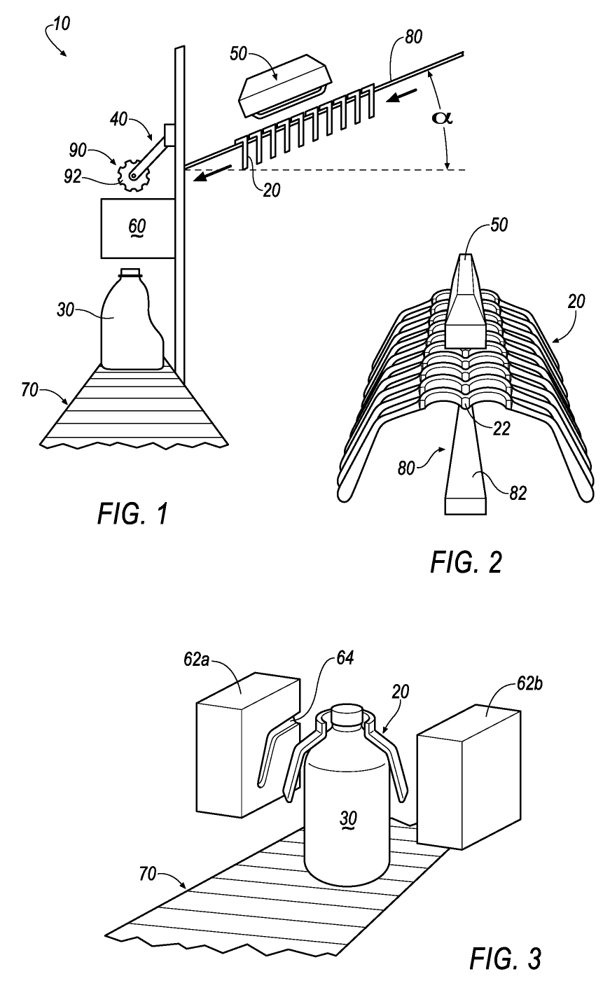

An embodiment of an apparatus 10 for applying a handle 20 to a container 30 is generally illustrated in FIG. 1. The illustrated embodiment includes a handle supply mechanism 40, a heater or heating unit 50, a handle applicator 60, and a container conveyance mechanism 70.

In an embodiment, such as generally illustrated in connection with FIGS. 1 and 2, the handle supply mechanism 40 may include a supply bar 80 and a handle release device, generally indicated as 90. In an embodiment, as shown, supply bar 80 may be provided at an angle (e.g., angle α) relative to a ground or base level to utilize gravity, in whole or in part, to feed handles 20 (in an “open configuration”) to a handle release device 90. In an embodiment of the invention, the angle α may, without limitation, range from about 1 degree to about 60 degrees and may be controlled or adjusted (increased or decreased) by mechanical means to help provide a desired supply rate of handles. That is, the angle a of the supply bar 80 can, for instance, be controllably adjusted (e.g., by an actuator or mechanical means) to provide an angle of descent in connection with the handles that may coincide with a desirable timing or removal frequency.

Supply bar 80 may, for example, be comprised of a metal and/or plastic material. In an embodiment, the supply bar 80—or portions thereof (e.g., surface portions) may be comprised of, or include a surface material that facilitates the movement of a plurality of handles. For example, without limitation, illustrated surface 82 may include a material (which may include a coating) that improves the sliding of handles 20 down an associated supply bar 80. For example, the material and/or coating may be selected to reduce the associated sliding friction between the handles 20 and the associated surface 82. In an embodiment, a plurality of handles may be provided to the supply bar in the form of a “magazine” of handles that are configured for loading into the system in volume.

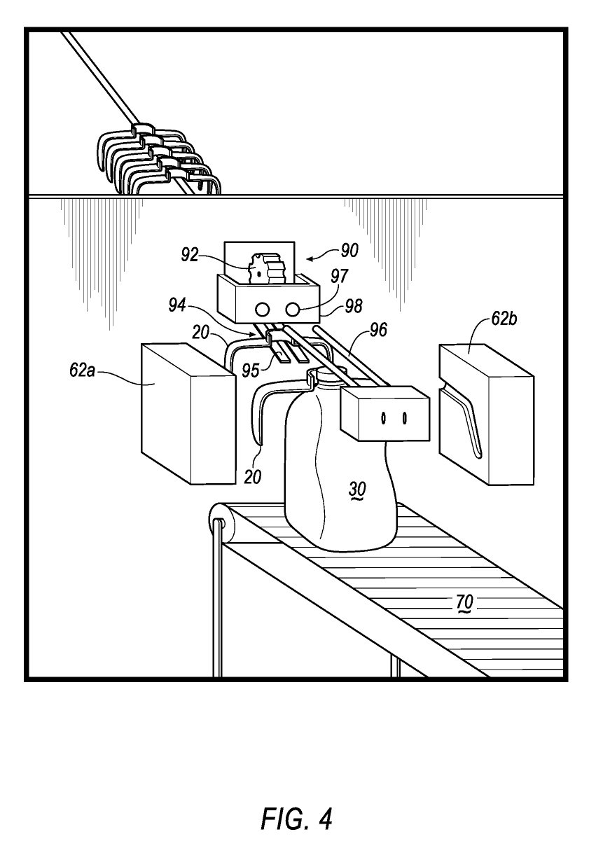

A release device 90 according to embodiments of the invention, is generally illustrated in FIGS. 1 and 4. Release device 90 may include one or more devices for separating/spacing individual handles in queue. In an embodiment, release device 90 may include an index wheel 92 and an associated release mechanism to assist with releasing a single handle at a desired point in time for subsequent application. As generally illustrated in FIG. 4, the release mechanism 94 may, for example, include one or more slides 95 one or more rods or pins 96 that extend through one or more corresponding apertures 97 provided in a surface 98 adjacent the index wheel 92 and above slides 95. In an embodiment, one or more rods or pins 96 translate beyond one or more corresponding apertures 97 such that in an advance position (closer to the index wheel 92) handles are restrained, and in a retracted position (such as illustrated) handles are permitted to advance down one or more slides 95 to meet up with a container. Further, in an embodiment, the apparatus may be configured such that an incremental rotation of an index wheel 92 is coordinated or synchronized with the movement of one or more rods or pins 96 to release a single handle 20 down the one or more slides 95 for subsequent application. Moreover, in an embodiment, the translation (advancement and/or retraction) of the one or more rods or pins 96 may be controlled by a servo motor (not shown). Further, for some embodiments, the release mechanism 94 may be activated to release a handle for application (e.g., by handle applicator 60) in response to a control parameter—which may be associated with the position and/or supply timing of the containers. However, it is noted that the supply mechanism is not limited to the specific supply mechanism 40 (and components thereof) that are generally illustrated. That is, the components of the supply mechanism—such as the supply bar 80 and release device 90—that are disclosed are exemplary only, and the invention is not limited to the specific mechanisms that are illustrated and described.

With continuing reference to FIG. 1, one or more heaters or heating units 50 may be provided and directed to handles 20 supplied in queue via supply mechanism 40. In an embodiment, a heater 50 is configured to heat a desired segment or portion of each handle 20. While it is possible to attach or connect a handle 20 to a container 30 at room temperature, it has been found that for many applications, including some involving higher speeds and a need for more force to “snap” a handle in place, it can be advantageous to supply energy/heat to target areas (e.g., areas or portions of a handle potentially subject to higher stress), such as the “hinge” portion of an “open” handle 20 to facilitate flexing of desired portions of the handle. Whereas a given handle design (material and structure) may have a preferential temperature range associated with assembly, heater 50 may include a control and a sensor and be configured to provide handles for application that are within a specific temperature range.

In an embodiment, the preferential temperature range may be at an elevated temperature—which may be above ambient or room temperature and below the melting point of the material comprising the handle. Moreover, in an alternate embodiment, each handle 20 may be provided to an application location without the added step of heating, provided the desired portion of the handle is already at such an elevated temperature that is higher than the container to which it is intended to be attached and may be within a preferred temperature range. For example, without limitation, this may be accomplished by supplying new or sufficiently recently produced handles, which may retain residual heat from an associated molding process, directly onto the handle supply bar 80. Without limitation, handles 20 may be injection molded and, as such, could retain a great deal of heat/energy upon mold exit. The time and conditions of movement to handle supply bar 80 could further be used to impact or determine the temperature at various areas of each handle at application.

Further, and without limitation, as generally illustrated in FIG. 2, heater 50 may be configured to direct or target heat substantially on or about a middle or hinge portion 22 associated with each handle 20. Such a configuration can be used to efficiently supply energy/heat to desirable portions of a handle without providing energy/heat to other portions of the handle where such energy/heat may not be needed or desirable. Without limitation, the heater or heating unit 50 may provide electric (e.g., coil), infrared, or ultrasonic energy/heat. The heater 50 may provide energy/heat that is controllably (and possibly automatically) synchronized with the supply mechanism 40—such as via a sensor or feedback control—to, for example, take into account and/or adjust the timing, position, or intensity associated with the heating based on the presence and/or supply rate of the handles 20. In other embodiments, the heater 50 may be configured to adjust energy/heat based on temperature readings, line speed, device malfunction, or shut down or slow down of associated components or machines (e.g., molders, conveyors, fillers, etc.).

FIG. 3 is a general representation of an embodiment of a handle applicator 60. As illustrated, handle applicator 60 may include a pair of opposing members—e.g., face plates 62a, 62b. Face plates 62a, 62b may each further include one or more recesses (e.g., illustrated recess 64 shown in 62a) configured to receive and/or temporarily support a portion of a handle 20. In embodiments of the invention, including those intended for running at production-level speeds, at least 15 handles may be attached per minute. However, it is noted that for some embodiments of the invention 20 or more handles may be attached per minute.

By way of example, without limitation, some forms of separate handles that may be employed in connection with the present invention include those disclosed in connection with Applicant's co-pending U.S. patent application Ser. No. 11,841,312, incorporated herein by reference. In an embodiment, face plates 62a, 62b may be configured to apply a force or pressure to snap or connect corresponding portions of a handle 20 about a container 30. For some applications or embodiments, the opposing members (e.g., face plates) may be used to, in part, melt or meld portions of the handle together—for example, through the application of ultrasonic welding.

In the illustrated embodiment, the container conveyance mechanism 70 generally comprises a conveyor. However, the invention is not limited to such a method of conveyance or transportation, and other forms of conveyance known to those of skill in the art may instead be used without departing from the scope and spirit of the present invention. It is also noted that the direction of conveyance of the containers 30 to a handle application point may be varied without departing from the scope and spirit of the invention. For example, in FIG. 1, the direction of conveyance of container 30 is generally perpendicular to the supply of the handles, while in FIG. 4, the direction of conveyance is generally parallel with the direction of supply of the handles.

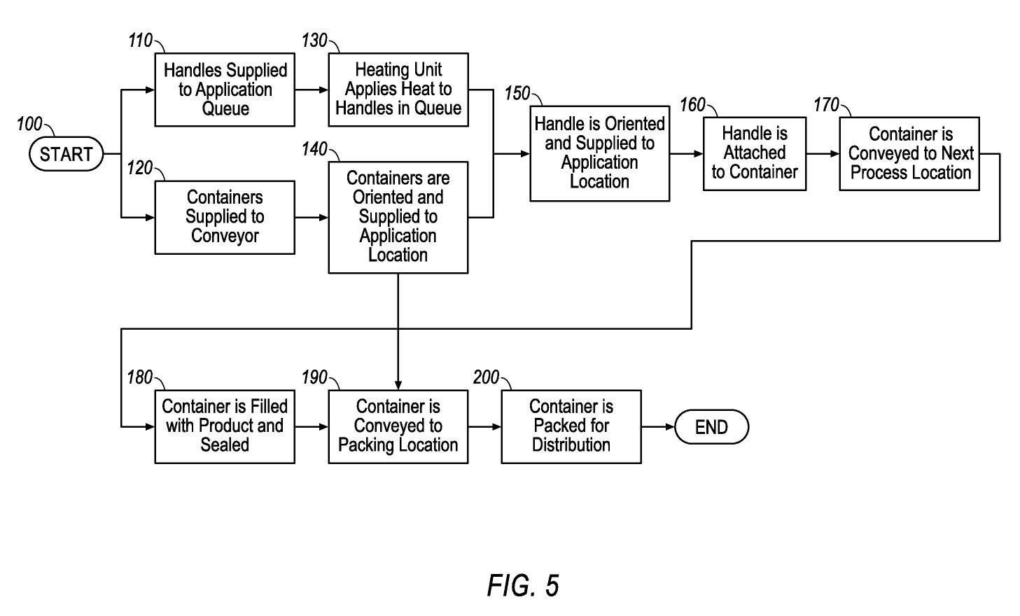

FIG. 5 provides a flowchart of a method for applying a handle to a container in accordance with aspects of the present invention. As generally illustrated, with reference to a somewhat arbitrary initial starting point (“Start”) 100, handles are supplied in an application queue (step 110) and containers are supplied to a transportation means, such as a conveyor (step 120). The handles are moved past a heating unit, which applies energy/heat to at least a portion of the handles in queue (step 130). The transported containers are supplied to an application location in an oriented configuration (step 140). The “opened” handle is then controllably supplied to the application location (step 150) and the handle is attached or connected to the container (step 160). The container—which now includes a handle—is then conveyed to the next processing location (step 170).

In embodiment of the system or process, the container may then be provided to a filling location where the container is filled with product and appropriately sealed and/or closed (step 180). After filling and sealing and/or closure, the container may be transported to a packing location (step 190) and the containers may be packaged for further distribution (step 200).

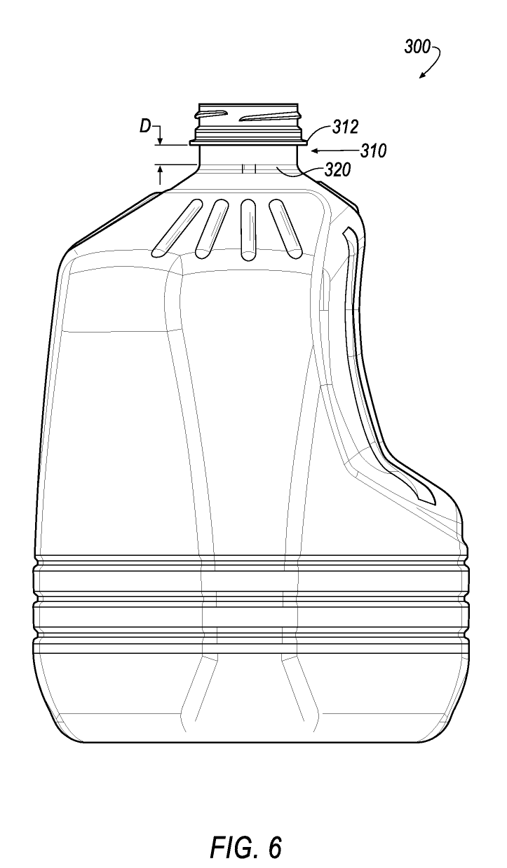

FIG. 6 generally illustrates a container 300 that may be utilized in connection with embodiments of the invention. As generally illustrated, container 300 may include a handle engagement portion 310 below a support ring or flange 320 that provides a segment or portion for engaging a separate handle. In the illustrated embodiment, the handle engagement portion 310 includes a straight-wall segment having a distance D (in this case a vertical distance) that is sufficiently long to accommodate a corresponding portion of a separate handle when the handle is positioned to substantially circumscribe the handle engagement portion 310. In an embodiment distance D is at least 4.0 mm, and for some embodiments may be 9-10 mm or greater.

Moreover, if desired, container 300 may include one or more structural reinforcement formations, for example and without limitation, one or more annular bands 320. In addition to, or in lieu of, reinforcement formations, container 300 may include thickened portions or segments (e.g., in the neck and/or upper regions). Such reinforcement formations and/or thickened portions or segments may be selectively configured to help resist undesirable deformation (e.g., buckling) that can commonly be associated with the lifting of a container (particularly a filled container) by a handle.

Without limitation, the containers and handles associated with the present invention may be comprised of plastic. Embodiments of handles used in connection with the invention may be comprised of, for example, polyethylene (PE), polypropylene (PP), and/or polyethylene terephthalate (PET), and may be injection or compression molded. Similarly, containers according to embodiments may be comprised of similar materials and may be formed via blow molding or other known manufacturing techniques.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims appended hereto and their equivalents.

What is claimed is:

1. An apparatus for attaching a handle to a container, the apparatus comprising:
a handle supply mechanism configured to supply one or more handles in an open configuration;
a heater configured to provide energy/heat to at least a portion of the one or more handles;
a container conveyance mechanism configured to provide a container to a handle application location; and
a handle applicator configured to attach or connect a handle that supplied initially in an open configuration to a portion of a container.

2. The apparatus of claim 1, wherein the handle supply mechanism includes a supply bar.

3. The apparatus of claim 2, wherein at least a portion of the supply bar include a surface material or coating.

4. The apparatus of claim 2, wherein the supply bar is provided at an angle relative to a ground or base level.

5. The apparatus of claim 4, wherein the angle may be mechanically controlled or adjusted.

6. The apparatus of claim 5, wherein the angle is mechanically controlled or adjusted to provide an angle of descent for said handles that is related to a timing or frequency associated with handle application.

7. The apparatus of claim 1, wherein the handle supply mechanism includes a handle release device.

8. The apparatus of claim 7, wherein the handle release device includes a device for separating or spacing individual handles.

9. The apparatus of claim 8, wherein the device for separating or spacing includes an index wheel.

10. The apparatus of claim 9, wherein the handle release device further includes one or more slides configured to support a portion of a handle during a transition between the index wheel and the handle applicator.

11. The apparatus of claim 7, wherein the handle release device includes one or more rods or pins that are configured to move or translate such that in a first position a handle is retained, and in a second position a handle is released for application.

12. The apparatus of claim 11, wherein the movement or position of the one or more rods or pins are operatively activated or controlled in response to a control parameter associated with the position or supply timing of a container.

13. The apparatus of claim 1, wherein the heater is configured to apply energy to or heat a specific segment or portion of a handle.

14. The apparatus of claim 1, wherein the heater provides electrical, infrared, or ultrasonic energy or heat.

15. The apparatus of claim 1, wherein the heater is configured to apply energy to or heat a hinge portion of a handle.

16. The apparatus of claim 1, wherein the heater is configured to sense a heat associated with the handle or its environment and adjust to maintain a portion of said handle within a select temperature range.

17. The apparatus of claim 1, wherein the handle applicator includes a pair of opposing members that are configured to exert a force or pressure to connect a portion of a handle being applied to a container.

18. The apparatus of claim 1, wherein the opposing members comprise face plates.

19. The apparatus of claim 18, wherein one or both of the face plates include one or more recesses configured to receive a portion of a handle.

20. The apparatus of claim 1, wherein the conveyance mechanism includes a conveyor.

21. A method for applying a handle to a container comprising:
providing a plastic handle in an open configuration in a queue;
selectively heating a portion of the plastic handle;
providing a container at an application location;
attaching or connecting the plastic handle to the container.

22. The method of claim 21, wherein a pair of opposing members apply a force or pressure to connect portions of the handle.

23. The method of claim 21, wherein the heater is configured to maintain the heat of a portion of the handle within a specified temperature range.

24. The method of claim 21, wherein the heater is configured to adjust energy/heat based on control signals associated with temperature readings, line speed, or the status of other machines associated with the manufacture, handling, or filling of the containers.

25. The method of claim 21, wherein a supply bar is used to provide the plastic handle in an open configuration in a queue, and an angle of descent associated with the supply bar is variably controlled.

26. The method of claim 21, wherein the container is oriented at or before the application location.

27. The method of claim 21, wherein the container with applied handled is transported directly to a filler.

28. A method for applying a handle to a container comprising:
providing a container at an application location; and
providing a plastic handle in an open configuration in a queue, the plastic handle having at least a segment or portion with an elevated temperature with respect to the container;
attaching or connecting the handle to the container.

29. The method of claim 28, wherein the elevated temperature is above ambient temperature and below the melting point of the segment or portion.
